(19) United States
(12) Patent Application Publication
(10) Pub. No.: US 2007/0074454 A1
(43) Pub. Date: Apr. 5, 2007

(54) Bulkhead door

(76) Inventor: Hendrikus Willem Johannes Oomen, Ambt Delden (NL)

Correspondence Address: CHRISTIE, PARKER & HALE, LLP, PO BOX 7068, PASADENA, CA, 91109-7068, US

(21) Appl. No.: 11/243,524

(22) Filed: Oct. 3, 2005

(51) Int. Cl. E05F 1/00

(52) U.S. Cl. 49/379

(57) ABSTRACT

A bulkhead door for a ship, which includes a door sheet, a gasket arranged along the periphery of the door sheet for cooperation with a knife edge of a door frame, and a strengthening rib extending along the periphery of the door sheet near the gasket. The strengthening rib arranged perpendicular to the door sheet.

The invention relates to a bulkhead door for a ship. Doors in ships need to be, in closed position, watertight. During storms, waves may flush over a ship and if a door is not watertight, the water could enter the ship and cause it to sink. It is therefore necessary that doors and bulkheads of ships can withstand a certain water pressure before they start leaking. Such doors are also used for closing off compartments within the ship. For example, if a compartment is flooded by a puncture of the ship hull, one could seal off the compartment by closing the respective doors. This will generally prevent the ship from sinking. Again, it is necessary for such doors to be watertight and to withstand a certain water pressure.

For example, U.S. Pat. No. 5,199,369 describes a bulkhead door. This door has a door frame and a door sheet, which closes the opening in the door frame. A gasket is arranged on the door sheet in order to seal off the door sheet against the door frame. Furthermore, the door sheet is strengthened by a circumferential rib. This rib provides stiffness to the door sheet and prevents bending of the door sheet, which could cause the door to start leaking.

In FIG. 5, a first embodiment 10 according to the prior art is shown. This bulkhead door 10 according to the prior art has a door sheet 12 with a bent back edge 14. The door is strengthened by a strengthening beam 16. This beam 16 is manufactured from, for example, a plate, which is bent in the desired shape. The strengthening beam has a protrusion 18, which retains, together with the bent back edge 14, a gasket 20. When the door 12 is locked by a locking mechanism (not shown) the gasket 20 is pulled against a knife edge 24 of a door frame.

The strengthening beam 16 is difficult to manufacture, especially in the corners of the door. The door frame of a bulkhead door must always have rounded corners in order to minimize stresses in these corners. When square corners would be used, the stresses in these corners are unacceptably high and would cause tears in the bulkhead material as a result of the movements in the hull of a ship, when it is at sea.

Although the shown strengthening beam 16 has an advantageous cross-sectional shape with regard to strength and stiffness, it is extremely difficult to provide a curved bend in such a beam 16. These curves are, however, necessary in order to provide the necessary stiffness to the door sheet 12.

FIG. 6 shows a cross-sectional view of a bulkhead door 30 according to the prior art. This bulkhead door 30 has a door sheet 32 with a bent back edge 34. The door is strengthened by a rolled beam 36. This rolled beam 36 has a protrusion 38, which contains, together with the bent back edge 34 of the door blade 32, a gasket 40. The gasket 40 is provided together with the knife edge 42 of a door frame for the sealing of the door.

The rolled profile 36 is still difficult to bend into rounded corners. Also the costs for manufacturing a rolled profile are high, and its manufacture is only cost effective when many bulkhead doors to be made. This is often not the case and thus provides increased costs for a door according to the embodiment shown in FIG. 6.

### SUMMARY

Embodiments of the invention provide a bulkhead door, which can be manufactured at lower costs and still provide the necessary water tightness.

A bulkhead door includes a door sheet, a gasket arranged along the periphery of the door sheet for cooperation with a knife edge of a door frame, and a strengthening rib extending along the periphery of the door sheet near said gasket. The strengthening rib is a strip perpendicularly arranged relative to the door sheet.

By using a simple strip for providing the strengthening rib the costs may be considerably reduced. A strip can provide the necessary stiffness to a bulkhead door, thus ensuring the necessary resistance to a certain water pressure. Furthermore, the strip is easily bent into rounded corners and can afterwards be welded to the door sheet.

In one embodiment, the strip includes a recess on one side and the door sheet includes a bent back edge. The gasket is retained by the bent back edge and the recess. This arrangement is beneficial because the gasket needs to be regularly replaced to ensure sufficient watertightness of the door.

In another embodiment, the strengthening rib is modular, including straight modules and bent corner modules. This facilitates manufacturing of doors having different dimensions. The bent corner modules can easily be connected to the straight modules, which are cut off at the desired length. In such way, a minimal amount of material needs to be in stock in order to be able to quickly manufacture doors at desired dimensions.

It is also possible to provide modules with both straight and bent portions, for example such that with only two modules a complete strengthening rib for a door can be provided.

Embodiments of the invention also include a method for manufacturing a bulkhead door for a ship. The embodiment of a method includes providing a metal door sheet, providing a metal strip, bending the metal strip to the contours of the metal door sheet, and welding the bent strip to the door sheet, such that the strip extends along the periphery of the door sheet. The method further includes arranging a gasket near the bent strip.

In one embodiment of the method according to the invention, the method also includes bending the edge of the metal door sheet and providing the metal strip with a recess, such that such gasket can be retained by the recess in the strip and the bent back edge of the door sheet. The recess in the metal strip can be provided by milling or grinding, or the strip can be manufactured with a recess by rolling.

### BRIEF DESCRIPTION OF THE DRAWINGS

These and other features of the invention will be elucidated in conjunction with the accompanying drawings.

FIG. 1 shows a perspective view of a ship with a bulkhead door according to one embodiment of the invention.

FIG. 2 shows a schematic perspective view of the door shown in FIG. 1.

FIG. 3 shows a cross-sectional perspective view of a part of the door shown in FIG. 2.

FIG. 4 shows a cross-sectional view of a part of the door according to FIG. 2.

FIG. 5 shows a cross-sectional view of a bulkhead door according to the prior art.

FIG. 6 shows a cross-sectional view of another embodiment of a bulkhead door according to the prior art.

### DETAILED DESCRIPTION

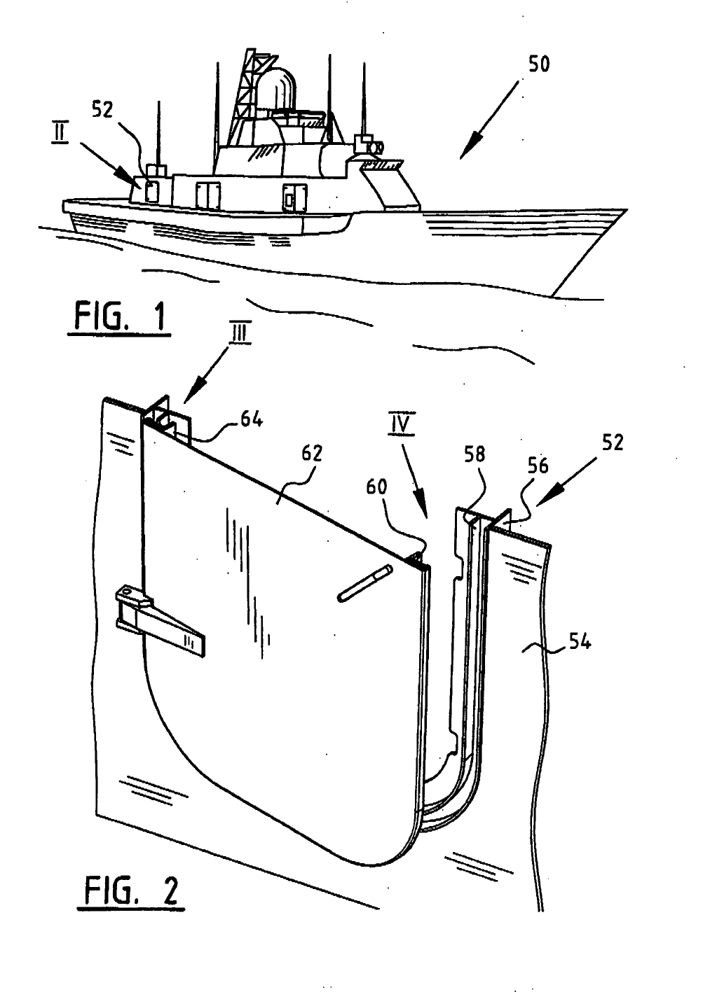

FIG. 1 shows a marine ship 50 with a door 52 according to one embodiment of the invention. In FIG. 2, the door 52 is shown in more detail. The door 52 is arranged in the bulkhead 54 in which a door frame 56 is arranged. The door frame 56 has a knife edge 58, which will couple together with the gasket 60 in watertight sealing.

The door 52 has a door sheet 62 on which a strengthening rib 64 is arranged.

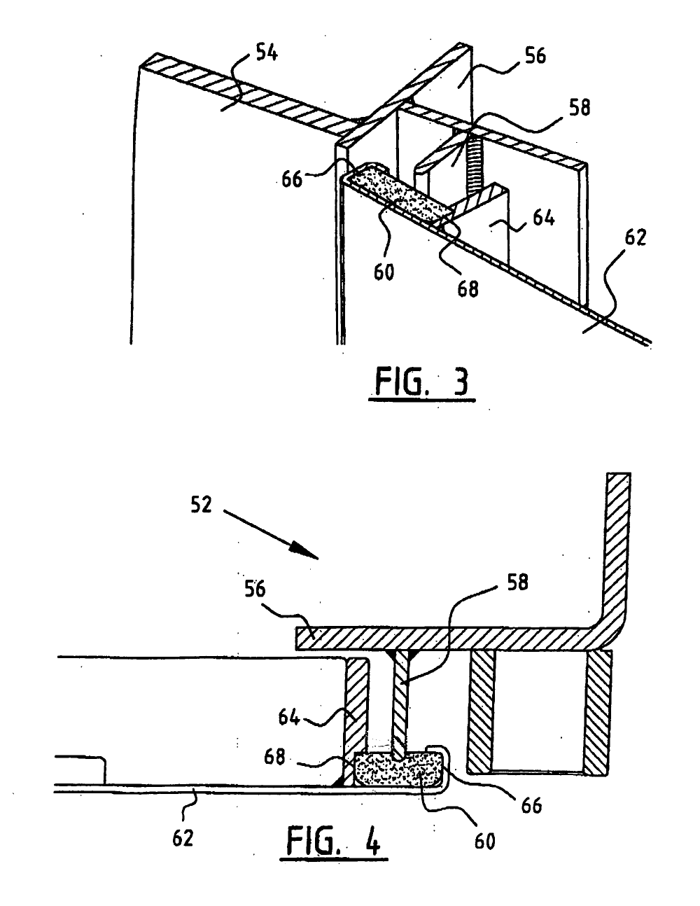

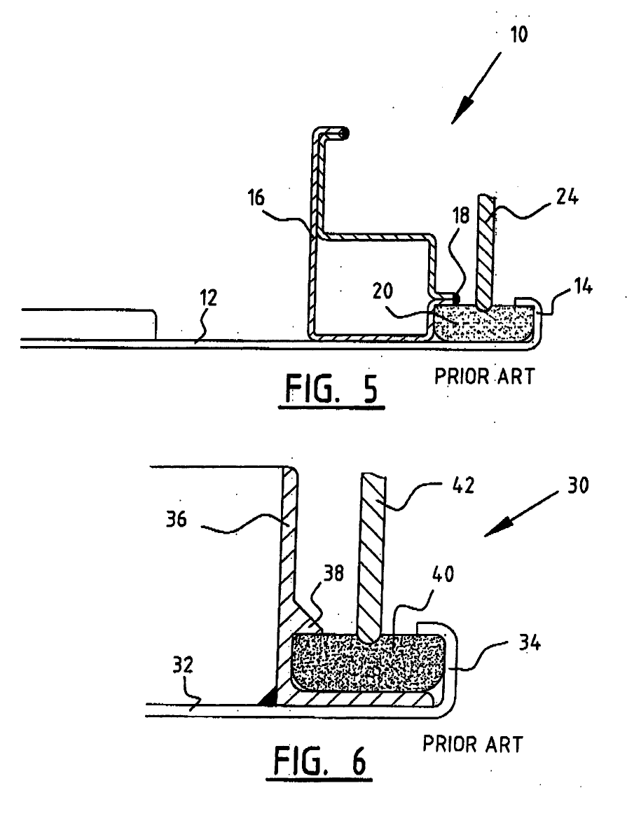

FIG. 3 shows the door 52 in more detail. The door sheet 62 has a bent back edge 66 and the strengthening rib 64 has a recess 68, such that the gasket 60 is retained by the bent back edge 66 and the recess 68 (see also FIG. 4).

The strengthening rib 64 is manufactured from a simple strip of metal, in which the recess 68 is arranged by, for example, milling or grinding. It also is possible for manufacturing larger quantities to arrange the recess 68 by rolling.

In FIG. 4 the door 52 is shown in a closed position. When the door 52 is pulled against the door frame 56, the knife edge 58 is pressed into the gasket 60, ensuring watertight sealing of the door 52.

1. A bulkhead door for a ship, said bulkhead door comprising:
a door sheet;
a gasket arranged along a periphery of the door sheet for cooperation with a knife edge of a door frame; and
a strengthening rib extending along the periphery of the door sheet near the gasket,
wherein the strengthening rib is in a shape of a strip and is arranged perpendicularly to the door sheet.

2. The bulkhead door according to claim 1, wherein the strip comprises a recess on one side and wherein the door sheet comprises a bent back edge, such that the gasket is retained by the bent back edge and the recess.

3. The bulkhead door according to claim 1, wherein the strengthening rib is modular, and comprising at least one straight module and at least one bent corner module corresponding to a corner of the door sheet.

4. A bulkhead door assembly for a ship the bulkhead door assembly comprising:
a door frame having a frame for arrangement in a bulkhead of the ship, and a knife edge extending outwardly from and around the frame;
a bulkhead door comprising:
a door sheet;
a gasket arranged along a periphery of the door sheet for cooperation with the knife edge of the door frame; and
a strengthening rib extending along the periphery of the door sheet near the gasket, wherein the strengthening rib is a in a shape of a strip that is bent along corners of the door sheet, the bent strip being arranged perpendicularly to the door sheet; and
a locking mechanism for locking the bulkhead door to the door frame, such that said knife edge is pressed into the gasket.

5. The bulkhead door assembly according to claim 4, wherein the bent strip comprises a recess on one side, and wherein the door sheet comprises a bent back edge, such that the gasket is retained by the bent back edge and the recess.

6. The bulkhead door according to claim 4, wherein the strengthening rib is modular, and includes at least one straight module and at least one bent corner module corresponding to a corner of the door sheet.

7. A method for manufacturing a bulkhead door for a ship, said method comprising:
providing a metal door sheet;
providing a metal strip;
bending said metal strip to the a corner of the metal door sheet to form a bent strip;
welding the bent strip to the door sheet, such that the bent strip extends along a periphery of the door sheet; and
arranging a gasket near the bent strip along the door sheet.

8. The method according to claim 7, further comprising:
bending an edge of the metal door sheet; and
providing the metal strip with a recess, such that the gasket can be retained by the recess in the strip and the bent back edge of the door sheet.

9. The bulkhead door according to claim 1, wherein the strip is substantially straight and extends from the door sheet.

10. The bulkhead door according to claim 1, wherein the strip has an end that is in contact with the door sheet.

11. The bulkhead door according to claim 1, wherein the gasket is in contact with the door sheet.

12. The bulkhead door assembly according to claim 4, wherein the strip is substantially straight and extends from the door sheet.

13. The bulkhead door assembly according to claim 4, wherein the strip has an end that is in contact with the door sheet.

14. The bulkhead door assembly according to claim 4, wherein the gasket is in contact with the door sheet.
